(19) United States
(12) Patent Application Publication
(10) Pub. No.: US 2009/0162493 A1
(43) Pub. Date: Jun. 25, 2009

(54) Confectionery product

(76) Inventor: Mark Edward Jones, Middlesex (GB)

Correspondence Address: HOFFMANN & BARON, LLP, 6900 JERICHO TURNPIKE, SYOSSET, NY, 11791, US

(21) Appl. No.: 11/631,455

(22) PCT Filed: Jul. 5, 2005
(86) PCT No.: PCT/GB05/02625

§ 371 Date: Sep. 30, 2008

(30) Foreign Application Priority Data
Jul. 5, 2004 (GB) 0415038.9

(51) Int. Cl. A23G 1/54

(52) U.S. Cl. 426/87; 426/103

(57) ABSTRACT

A confectionery product (10) comprises a first hollow chocolate body (11), located within a second hollow chocolate body (14). The exterior of the firt hollow chocolate body is substantially covered with a layer of inedible protective material (13). The protective material (13) may be an aluminium foil on which there is no printing. The foil may be coated in a vinyl lacquer to lubricate it as it passes through a foil machine during manufacture of the product. The second chocolate body (14) may also be covered with a layer of protective material (15), which may also be a foil. A bag (12) of plastics material containing gifts and/or further confectionery products may be provided within the first chocolate body. The first and second chocolate bodies may be Easter eggs. In a further embodiment a third hollow chocolate body (16, FIG. 2) is provided around the second hollow chocolate body.

The present invention relates to confectionery products and particularly, but not exclusively, to chocolate Easter eggs.

It is known to manufacture Easter eggs by separately moulding two halves of a chocolate shell, which when secured together form a hollow egg-shaped chocolate product. It is also known to manufacture a hollow egg-shaped chocolate product as a unitary item by means of a spin moulding process. It is common to include within the Easter egg a polythene or polypropylene film bag charged with small confectionery items, such as candies.

The present invention seeks to provide a new confectionery product, which in one embodiment is in the form of an Easter egg.

According to the present invention there is provided a confectionery product comprising a first hollow chocolate body, located within a second hollow chocolate body, wherein the exterior of the first hollow chocolate body is substantially covered with a layer of inedible protective material.

It is considered that this new product will be highly desirable to consumers.

In one embodiment the protective material, which may be a foil, is not coated with ink, as is common with known Easter egg products. This is because mechanical scuffing, arising from movement of the inner first egg within the outer second egg, may lead to transfer of the ink to the outer egg and hence tainting of the outer egg. Nevertheless a lacquer may be applied to the foil to lubricate it as it passes through the foil machine during manufacture of the product. A vinyl based lacquer may be used. Alternatively, the protective layer may be printed with an ink which is suitable for direct contact with a food product.

One or more further hollow chocolate bodies may be provided within the first body and/or around the second body.

One or more further confectionery items and/or gift items may be provided in the hollow of the innermost chocolate body and/or between adjacent chocolate bodies.

The weight of the first chocolate body may be in the range from 60 g to 125 g and in one embodiment is in the range from 109 g to 125 g.

The weight of the second chocolate body may be in the range from 120 g to 290 g and in one embodiment is in the range from 278 g to 290 g.

Each chocolate body may be moulded in two parts. The two parts of the first chocolate body may be joined together. Alternatively, the first chocolate body may be formed in one piece.

The shell dimensions (per half), in millimetres, for the first chocolate body may be substantially 108×72×35.

The shell dimensions (per half), in millimetres, for the second chocolate body may be substantially 151×100×50.5 or 131×90×45.

The thickness of the wall of the first chocolate body may be in the range from 2.8 mm to 4.8 mm, and in one embodiment is in the range from 4.6 mm to 4.8 mm.

The thickness of the wall of the second chocolate body may be in the range from 3.0 mm to 5.8 mm and in one embodiment is in the range from 4.0 m to 5.8 mm.

In order that the present invention may be more readily understood, specific embodiments thereof will now be described, by way of example only, with reference to the accompanying drawings in which:—

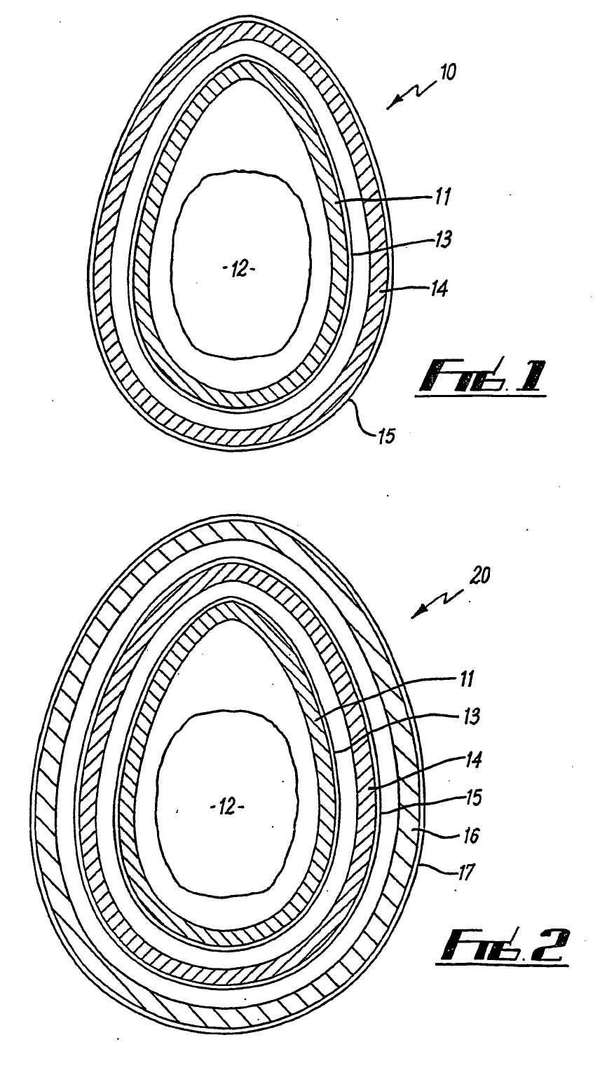

FIG. 1 is a first chocolate product in accordance with the present invention; and

FIG. 2 is a second chocolate product in accordance with the present invention.

In the drawings the same reference numerals are used to illustrate like parts.

Referring to FIG. 1 there is provided an Easter egg 10 comprising a first inner chocolate egg 11 made in two halves in conventional fashion. The inner egg is hollow and encapsulates one or more novelty gifts or confectionery products.

The gifts/confectionery products could be wrapped in a bag 12 of plastics material such as polythene or polypropylene. The interior of the first egg is not wrapped. The exterior of the first egg is wrapped with a layer of protective material, which in this embodiment is an aluminium foil 13 coated with a vinyl lacquer. This aluminium foil 13 is free of ink printing. In alternative embodiments, the protective layer can be formed from any suitable material and may be uncoated or coated in materials other than a vinyl lacquer. In a further alternative embodiment, the protective layer may be printed on using an ink or inks which are suitable for direct contact with food products.

The two halves of the first egg 11 may simply be held together by means of the protective layer 13 or they may be physically joined together. One method of joining the two halves together is to heat the rim of at least one of the halves to melt the chocolate at the rim before placing the two halves together. As the melted chocolate re-sets, the two halves will be joined to each other. Alternatively, the first egg 11 may be formed in one piece using a spin moulding technical known in the art.

A second egg 14, made in conventional fashion in two halves encapsulates the first egg such that a gap is provided between the two eggs 11, 14, albeit that the base of the first egg rests on the second egg. The inside of the second egg is not wrapped. The exterior of the second egg is wrapped with a layer of protective material that in this embodiment is also an aluminium foil 15. Such foil is printed with ink in conventional fashion to make the product attractive to the consumer. In alternative embodiments the protective layer can be formed from any suitable material such as a clear plastics material and need not be printed on. The two halves of the second egg 14 may be held together by the layer of protective foil 15 or they may be joined together as described in relation to the first, inner egg 11.

In the present embodiment, the shell dimensions (per half), in millimetres, for the inner first egg 112 are substantially 108×72×35 and the thickness of the wall of the inner egg is in the range from 2.8 mm to 4.8 mm, and, more particularly, in the range from 4.6 mm to 4.8 mm. Accordingly, the weight of the inner first egg 11 is in the range from 60 g to 125 g and, more particularly, in the range from 109 g to 125 g.

Also in the present embodiment, the shell dimensions (per half), in millimetres, for the second outer egg 14 are substantially 151×100×50.5 or 131×90×45 and the thickness of the wall of the second outer egg is in the range from 3.0 mm to 5.8 mm and, more particularly, in the range from 4.0 mm to 5.8 mm. Accordingly, the weight of the second chocolate body is in the range from 120 g to 290 g and, more particularly, in the range from 278 g to 290 g.

It will be appreciated that the dimensions of the first inner egg 11 and/or the second outer egg 14 can be varied as required and that the invention is not necessarily limited to confectionary products having the dimensions set out above.

Referring to FIG. 2 a second embodiment 20 of the invention is shown. This is similar to that illustrated in FIG. 1 except in that the foil 15 surrounding the second egg 14 is not printed with ink, but is instead the same as that used to wrap the first egg 11 of FIG. 1. Alternatively, the foil 15 surrounding the second egg 14 may be printed on with an ink or inks that are suitable for direct contact with food products.

A third egg 16, manufactured in two halves in conventional fashion encapsulates the second egg 14 such that a gap is provided between the two eggs 14, 16, albeit that the base of the second egg 14 rests on the third egg 16. The inside of the third egg 16 is not wrapped. The exterior of the third egg 16 is wrapped with aluminium foil 17. Such foil 17 is printed with ink in conventional fashion to make the product attractive to the consumer.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention. For example, whilst the invention has been described in relation to Easter eggs it can be equally applied to products in which the chocolate bodies have different shapes. For example the hollow chocolate bodies may be formed in the shape of characters, such as chocolate Santas, or in the form of chocolate Russian dolls.

Were the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

1-24. (canceled)

25. A confectionery product comprising a first hollow chocolate body, located within a second hollow chocolate body, wherein the exterior of the first hollow chocolate body is substantially covered with a layer of inedible protective material.

26. The confectionery product of claim 25, wherein the thickness of the wall of the second chocolate body is in the range from 3.0 mm to 5.8 mm.

27. The confectionery product of claim 25, wherein the thickness of the wall of the second chocolate body is in the range from 4.0 mm to 5.8 mm.

28. The confectionery product of claim 25, wherein the protective material is a foil.

29. The confectionery product of claim 25, wherein the layer of protective material is free from printing.

30. The confectionery product of claim 25, wherein the layer of protective material is printed on using an ink or inks suitable for directed contact with a food product.

31. The confectionery product of claim 25, wherein the layer of protective material is coated in lacquer.

32. The confectionery product of claim 31, wherein the lacquer is a vinyl based lacquer.

33. The confectionery product of claim 25, wherein at least one further hollow chocolate body is provided within the first body and/or around the second body.

34. The confectionery product of claim 25, wherein at least one further confectionery item and/or gift items is provided in the hollow of the innermost chocolate body and/or between adjacent chocolate bodies.

35. The confectionery product of claim 25, wherein the weight of the first chocolate body is in the range from 60 g to 125 g.

36. The confectionery product of claim 25, wherein the weight of the first chocolate body is in the range from 109 g to 125 g.

37. The confectionery product of claim 25, wherein the weight of the second chocolate body is in the range from 120 g to 290 g.

38. The confectionery product of claim 25, wherein the weight of the second chocolate body is in the range from 278 g to 290 g.

39. The confectionery product of claim 25, wherein each chocolate body is moulded into two parts.

40. The confectionery product of claim 39, wherein two parts forming the first chocolate body are joined together.

41. The confectionery product of claim 25, wherein the first chocolate body is formed in one piece.

42. The confectionery product of claim 25, wherein the shell dimensions (per half), in millimetres, for the first chocolate body are 108×72×35.

43. The confectionery product of claim 25, wherein the shell dimensions (per half), in millimetres, for the second chocolate body are 151×100×50.5 or 131×90×45.

44. The confectionery product of claim 25, wherein the thickness of the wall of the first chocolate body is in the range from 2.8 mm to 4.8 mm.

45. The confectionery product of claim 25, wherein the thickness of the wall of the first chocolate body is in the range from 4.6 mm to 4.8 mm.

46. The confectionery product of claim 25, wherein the first and second chocolate bodies are Easter eggs.
